(19) United States
(12) Patent Application Publication
(10) Pub. No.: US 2003/0131633 A1
(43) Pub. Date: Jul. 17, 2003

(54) Spinning device for low polarization mode dispersion of optical fiber

(76) Inventors: Chang-Woong Jeong, Kumi-shi (KR); Yeong-Seop Lee, Kumi-shi (KR); Myung-Sop Lee, Kumi-shi (KR); Ki-Tae Jung, Kumi-shi (KR)

Correspondence Address: CHA & REITER, 411 HACKENSACK AVE, 9TH FLOOR, HACKENSACK, NJ, 07601, US

(21) Appl. No.: 10/331,204

(22) Filed: Dec. 30, 2002

(30) Foreign Application Priority Data
Jan. 17, 2002 (KR) 2002-2668

(51) Int. Cl. C03B 37/022

(52) U.S. Cl. 65/504

(57) ABSTRACT

Disclosed is a spinning device for low polarization mode dispersion. The spinning device for minimizing PMD(Polarization Mode Dispersion) of the drawn optical fiber in the optical fiber drawing process includes: a base plate arranged at a lower end of a drawing tower; a tilting spinning wheel mounted on the base plate for rotating along a first rotational shaft, for transferring a drawn optical fiber to a capstan, for periodically rotating along a second rotational shaft within a predetermined angle range at a perpendicular relation to the first rotational shaft, for applying a periodic twisting on the optical fiber using the tension of the drawn optical fiber with its outer periphery touched with the drawn optical fiber; and, a speed reducing unit connected to the second rotational shaft of the tilting spinning wheel for reducing the rotational speed of the wheel.

### CLAIM OF PRIORITY

This application claims priority to an application entitled “SPINNING DEVICE FOR LOW POLARIZATION MODE DISPERSION OF OPTICAL FIBER” filed in the Korean Industrial Property Office on Jan. 17, 2002 and assigned Serial No. 02-2668, the contents of which are hereby incorporated by reference.

### BACKGROUND OF THE INVENTION

1. Field of the Invention

The present invention relates to an optical fiber drawing equipment and, particularly to a spinning device for low polarization mode dispersion of an optical fiber.

2. Description of the Related Art

Generally, an optical fiber is fabricated by drawing a fine strip of the optical fiber from an optical fiber preform. The optical fiber fabricated through such process exhibit polarization mode dispersion characteristics.

Polarization Mode Dispersion (PMD) of the optical fiber increases bit-error rate by spreading the optical pulse transmitted through the optical fiber, thereby limiting data transmission capacity transmitted through the optical fiber. Such polarization mode dispersion is generated by the interaction between the physical property of the optical fiber and polarization status of a light passing through the optical fiber. A light used for the optical transmission behaves like an electromagnetic wave, which has two modes of polarization property. If the polarization axes of the two modes are perpendicular each other (phase difference of 90 degree) and their amplitudes are the same, then the electric field vector of polarized wave for the two planes is generated. In an ideal optical fiber, two principle axes exist, and these two axes are perpendicular each other. The directions of the principle axes are determined by the stress generated during the optical fiber drawing process. If the axis directions of the principle axes are not perpendicular each other, a difference in the refractive index for a polarized light is generated. This phenomenon is known as birefringence. If a difference in the refraction index of a material is generated, the speed of light transmitted through the optical fiber is changed depending on the axes, and this means that a relative phase difference of a light is changed accordingly. Two parts of the polarized light travel with different speeds, with time difference due to the birefringence of the optical fiber causes the reached light to get dispersed.

The PMD is known to be originated from the property of geometrical structure of the optical fiber core and the residual stress remaining in the optical fiber. Also, the external factors such as bending, twisting and heat distribution of the optical fiber, have an influence on the PMD. The residual stress generated during the optical drawing process consists of thermal stress originated from a difference between the physical properties of the optical fiber core and the cladding layer, and the mechanical stress originated from drawing tension. In order to resolve this problem, a variety of methods for reducing the residual stress of the drawn optical fiber, such applying heat treatment to the optical component, changing the refractive index of the fiber, and incorporating a grating element. Another known method involves arranging a low speed mode and a high speed mode periodically by twisting the optical fiber. Using these method, a total polarization dispersion has been minimized. Other related art for minimizing the PMD is described in a WO8300232, entitled a method for rotating the optical preform in order to twist the optical fiber and in U.S. Pat. Nos.: 5,298,047, 5,418,881, 5,704,960, 5,943,466, 6,148,131.

The foregoing related art, however, relies on the physical contact to apply the torque on the optical fiber during the optical fiber drawing process. In order to sufficiently lower the PMD through the twisting generated in the optical fiber, a number of twistings must be sufficient. That is, to increase the twisting, a sufficient torque force is required. However, during this process, there is high probability that the optical fiber coating characteristics is deteriorated due to the vibration of the optical fiber, or the optical fiber may fracture In addition, the application of torque through the physical contact increases the probability of mechanical defects to the surface of the optical fiber. As such, the strength of the optical fiber could be weakened especially in a high speed drawing of the optical fiber.

### SUMMARY OF THE INVENTION

According to one aspect of the present invention, a spinning device capable of realizing uniform spinning for the optical fiber is provided.

Another aspect of the present invention is to provide a spinning device capable of pursuing a stabilization when spinning for the optical fiber while the length of the drawn optical fiber is extended at a maximum.

According another aspect of the invention, a spinning device for minimizing PMD(Polarization Mode Dispersion) of the drawn optical fiber in the optical fiber drawing process includes: a base plate arranged on an extremely lower end of a drawing tower; a tilting spinning wheel mounted on the base plate, in an arranged status, for rotating on a first rotational shaft, for transferring a drawn optical fiber to a capstan, for periodically rotating on a second rotational shaft perpendicular to the first rotational shaft within a predetermined angle range, for applying periodic twisting on the optical fiber using tension of the drawn optical fiber with its outer periphery touched with the drawn optical fiber; and, a speed reducing unit connected to the second rotational shaft of the tilting spinning wheel for receiving power from a driving motor and for reducing the rotational speed.

### BRIEF DESCRIPTION OF THE DRAWINGS

The invention will be described in detail with reference to the following drawing in which like reference numerals refer to like elements wherein:

FIG. 1 is a structural view schematically illustrating the structure of a drawing tower to which a spinning device according to a preferred embodiment of the present invention is applied;

FIG. 2 is a front view illustrating a status in which a spinning device according to a preferred embodiment of the present invention is applied to an optical fiber in drawing process.

FIG. 3 is a plan view illustrating the structure of a spinning device according to a preferred embodiment of the present invention;

FIG. 4 is a plan view illustrating the structure of a spinning wheel of a spinning device according to a preferred embodiment of the present invention; and, FIG. 5a through FIG. 5c are exemplary views illustrating the procedures in which spinning is applied to an optical fiber by a spinning wheel.

### DETAILED DESCRIPTION OF THE PREFERRED EMBODIMENT

The following detailed description will present a spinning device for an optical fiber according to a preferred embodiment of the invention with reference to the accompanying drawings. For the purposes of clarity and simplicity, well-known functions or constructions are not described in detail as they would obscure the invention in unnecessary detail.

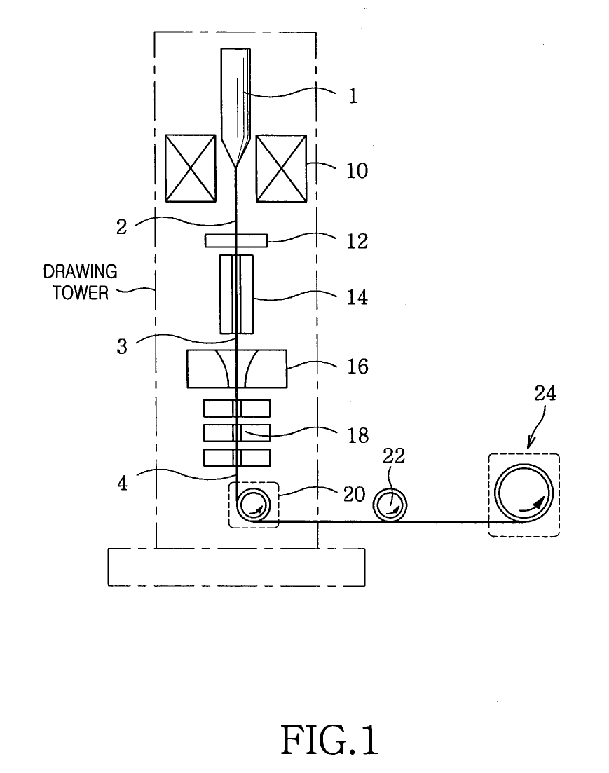

FIG. 1 is a structural view illustrating an optical fiber drawing equipment having a spinning device mounted on a drawing tower according to a preferred embodiment of the present invention. The inventive optical fiber drawing process is configured such that the drawing equipment is arranged in a processing order and mounted on the drawing tower of stand type, as shown in FIG. 1. An optical fiber preform 1 is melted in a melting furnace 10 at a sufficient temperature, so that the preform 1 is drawn in form of a fine strip of the optical fiber 2. The diameter of the drawn optical fiber 2 is controlled by a diameter controller 12, and the fiber 2 passes through a cooling unit 14, then cooled down to a suitable temperature before an optical fiber coating process. The cooled optical fiber 3 passes through a coater 16 to be coated. Thereafter, the optical fiber goes through an ultraviolet hardening unit 18 to harden the coated portion of the fiber. After that, the coated optical fiber 4 goes through a spinning device 20 where the twisting action is applied to the optical fiber, then the optical fiber to which spinning is applied moves to a capstan 22. The capstan 22 provides a predetermined tension to the optical fiber so that the optical fiber of a constant diameter can be drawn. Finally, the drawn optical fiber goes through the capstan 22, and passes through a guide roller (not shown) and is wound on a winder 24.

The spinning device 20 of the present invention is positioned at a lower end of the drawing tower for spinning the fiber uniformly and stably. Note that the optical fiber preform 1 is arranged in the highest position of the drawing tower, so when the distance between the optical fiber preform 1 and the spinning device 20 is maximized, the length of the drawn optical fiber becomes maximized. As such, the spinning device 20 is preferably located at the lowest allowable position of the drawing tower according to the teachings of the present invention.

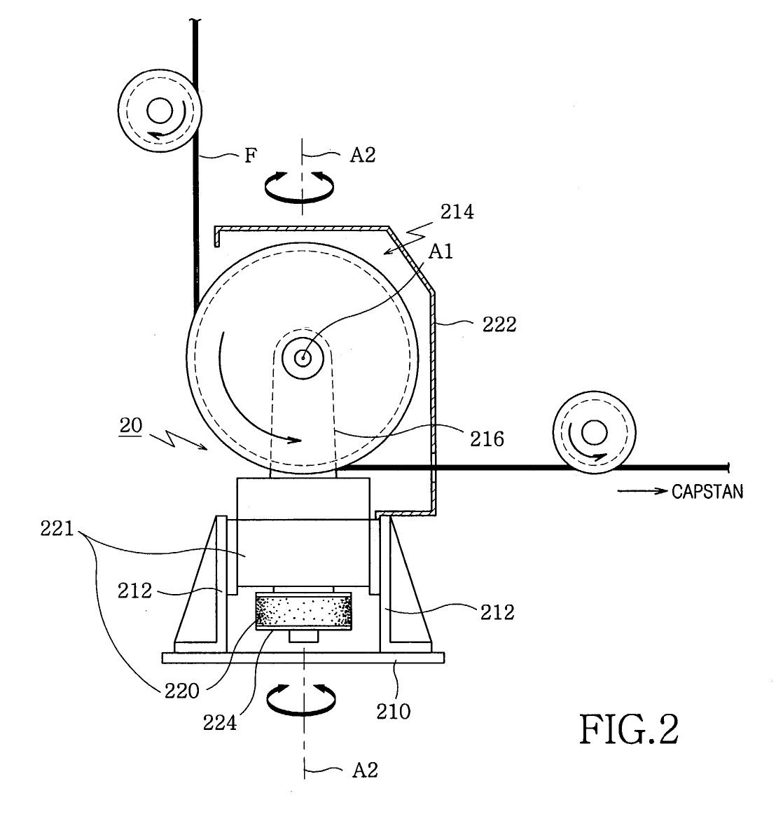

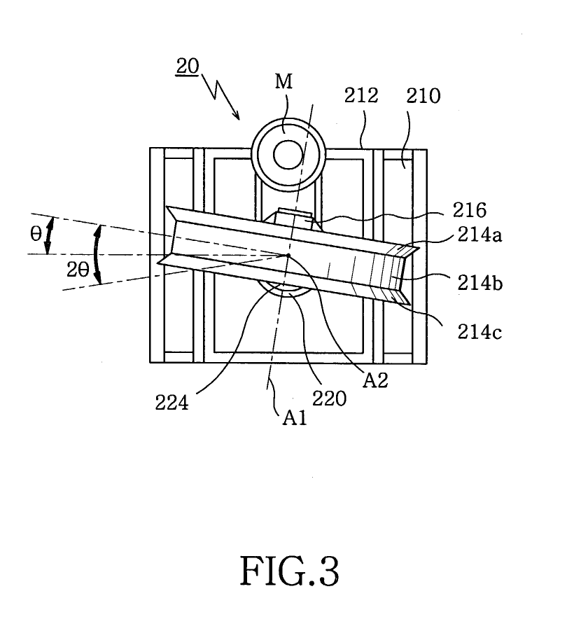

Now, the spinning device 20 will be described in detail with reference to FIG. 2 and FIG. 3 hereinafter.

As shown in FIG. 2 and FIG. 3, the spinning device 20 according to a preferred embodiment of the present invention includes: a base plate 210 arranged at the lower side of the drawing tower; a tilting spinning wheel 214 mounted on the base plate in a substantially vertical direction for applying twisting of the drawn optical fiber F; a power unit M for providing torque to rotate the tilting spinning wheel 214 in forward or reverse directions; and, a speed reducing unit 221 for reducing the rotational speed delivered from the power providing unit to less than a predetermined speed. The tilting spinning wheel 214 is mounted on the lower side of the drawing tower and arranged near the base plate 210 and a first supporting board 212, so that the optical fiber passing through the tilting spinning wheel 214 moves to a capstan. Particularly, the tilting spinning wheel 214 is mounted on the base plate 210 using a second supporting board 216.

Referring to FIG. 3, the power unit includes a driving motor M and mounted on the base plate 210. A timing belt 220 for delivering the power of the driving motor M is connected to a motor shaft (not shown) positioned at a lower end of the driving motor M, so that the timing belt is connected to a spinning wheel shaft 224 of the tilting spinning wheel. Here, the spinning wheel shaft 224 is connected to a rotational shaft (not shown) of the tilting spinning wheel, whereby the power is delivered. The tilting spinning wheel 214 further includes a cover mounted on the base plate 210 for enclosing the tilting spinning wheel 214.

The tilting spinning wheel 214 comes into contact with the drawn optical fiber F, while a periodic twisting is provided on the drawn optical fiber F by a mutual plane contact and tension held by the drawn optical fiber. In the meantime, the power providing unit M repeatedly provides a torque force in forward and reverse directions periodically to the tilting spinning wheel 214 within a predetermined angle range, and the speed reducing unit reduces the speed of the high speed driving motor M to less than a predetermined speed, thus playing a role of delivering the reduced torque to the rotational shaft of the tilting spinning wheel.

The driving motor M delivers power to the spinning wheel shaft 224 by means of the timing belt 220. In the spinning device, two speed reductions occur. Namely, when the driving motor M rotates, a first speed reduction occurs while the rotating power is being delivered to the spinning wheel shaft 224 by the timing belt 220. A second speed reduction occurs using a known teeth mechanism (not shown) while the power is being delivered to the spinning wheel shaft 224. The teeth mechanism reduces the speed by changing a number of teeth in the gear. For example, if a speed reduction of one tenth occurs while the power is being delivered to the spinning wheel shaft 224 from the driving motor M, then another speed reduction of one tenth occurs while the power is being delivered to the spinning wheel 214 from the spinning wheel shaft 224. As a result, the overall speed reduction of one hundredth occurs between the driving motor M and the spinning wheel.

As shown in FIG. 3, the tilting spinning wheel 214 according to the present invention is mounted obliquely at a predetermined angle ⊖ on the base plate 210.

A primary reason that the spinning device could apply a spinning force on the drawn optical fiber F is that the tilting spinning wheel 214 performs rotational motions repeatedly within a predetermined angle range with respect to a second rotational axis A1, while the optical fiber F is holding tension against the tilting spinning wheel 214. Namely, a tension spinning of the drawn optical fiber F is originated from the fact that the spinning wheel 214 is mounted obliquely at a predetermined angle on the base plate 210. The spinning wheel 214 rotates on a rotational axis A1, playing a role of transferring the drawn optical fiber F to the capstan, and simultaneously, providing periodic twisting to the drawn optical fiber F while rotating the spinning wheel 214 in forward and reverse directions. The ⊖ shown in FIG. 3 represents the rotational amount of the tilting spinning wheel F. Note that the rotational amount is about less than 5 degree, and the first rotational axis A2 lies at right angles to the second rotational axis A1.

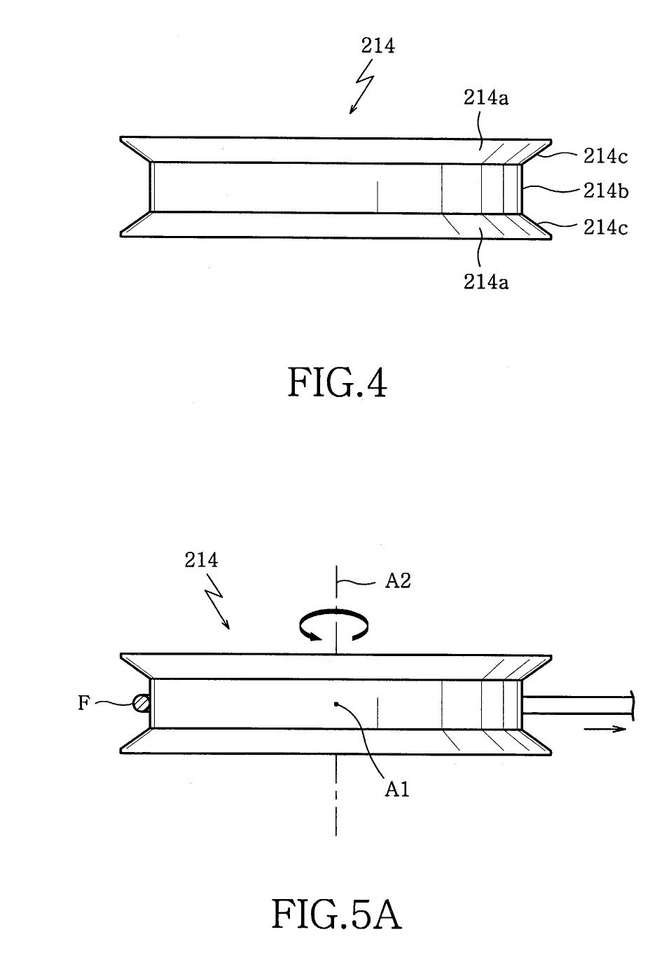

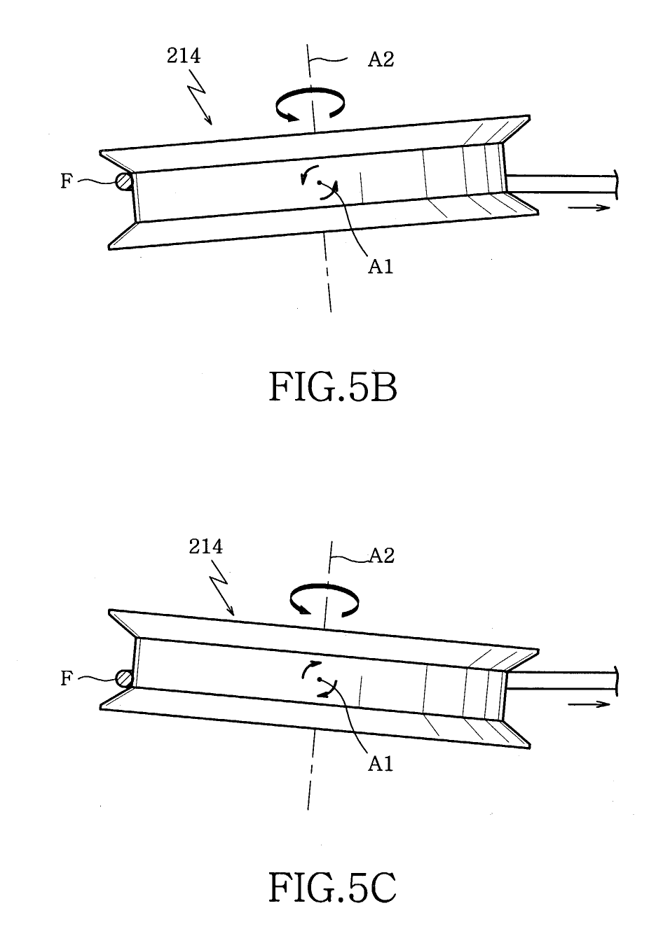

As shown in FIG. 4, the spinning wheel 214 includes projected portions 214a provided along the edge of its outer periphery, a concave portion 214b provided between the projected portions 214a, and an inclined plane 214c provided between the projected portion 214a and the concave portion 214b. The spinning wheel 214 comes into contact with the drawn optical fiber and assist in moving the drawn optical fiber to the capstan as it rotates. Note that as the spinning wheel 214 being obliquely mounted rotates, the drawn optical fiber comes into plane-contact with the spinning wheel and the spinning causes the optical fiber to translate along the body of the spinning wheel 214.

As shown in FIG. 5a through FIG. 5c, the driving motor rotates in forward and reverse directions while the generated torque is delivered to the spinning wheel 214. The power of the driving motor is selectively reduced and delivered to the spinning wheel 214. If the tilting spinning wheel 214 rotates on the second rotational axis A1 in forward and reverse directions, the drawn optical fiber F plane-touched with the spinning wheel is given a spin. The spinning given to the optical fiber F is periodically applied in forward and reverse directions. Namely, the spinning wheel 214 repeats the process shown in FIG. 5a through FIG. 5c, whereby a periodic spinning is provided to the drawn optical fiber F. It should be noted that the degree of twisting for the drawn optical fiber could be set with consideration of frictional coefficient or tilting degree of the spinning wheel, and the tilting angle or the frictional coefficient could be changed depending on the distance with respect to a guide wheel arranged in the rear side of the spinning wheel.

As is apparent from the foregoing, upon use of the spinning device according to the present invention mounted at the lower end of the drawing tower, the periodic twisting phenomenon is provided to the drawn optical fiber, whereby the polarization mode dispersion for the optical fiber could be minimized.

The foregoing embodiments and advantages are merely exemplary and are not to be construed as limiting the present invention. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structure.

What is claimed is:

1. A spinning device for minimizing a Polarization Mode Dispersion (PMD) of an optical fiber during an optical fiber drawing process, comprising:
a base plate arranged at a low end of a drawing tower;
a tilting spinning wheel mounted on the base plate for rotating along a first rotational shaft, for transferring the optical fiber to a capstan, for periodically rotating within a predetermined angel range along a second rotational shaft perpendicular to the first rotational shaft, and for applying a periodic twisting on the optical fiber; and
a speed reducing unit connected to the second rotational shaft of the tilting spinning wheel for reducing a rotational speed of the tilting spinning wheel.

2. The spinning device according to claim 1, wherein the tilting spinning wheel comprises: projected portions, each, provided along an outer edge of the tilting spinning wheel; a concave portion provided between the projected portions; and, an inclined surface provided between the projected portions and the concave portion.

3. The spinning device according to claim 1, further comprises a cover for protecting the tilting spinning wheel, wherein the cover is mounted on the base for enclosing the tilting spinning wheel.

4. The spinning device according to claim 1, wherein the tilting spinning wheel rotates on the second rotational shaft within an angle range of 10 degree.

5. The spinning device according to claim 1, further comprising a driving motor and a timing belt linking to a rotation shaft of the tilting spinning wheel.

6. The spinning device according to claim 5, wherein the tilting spinning wheel comes into contact with the optical fiber F while a periodic twisting motion is provided to the optical fiber rotated by the tilting spinning wheel.

7. The spinning device according to claim 5, the speed reducing unit reduces the speed of driving motor M to be less than a predetermined speed, thereby reducing torque applied to the rotation shaft of the tilting spinning wheel.
